(19) United States
(12) Patent Application Publication
(10) Pub. No.: US 2013/0087636 A1
(43) Pub. Date: Apr. 11, 2013

(54) SPRAY NOZZLE FOR ADDITION OF SUBSTANCES INTO A REACTIVE MIXTURE

(71) Applicant: Ernst Scheidt, Dachau (DE)

(72) Inventor: Ernst Scheidt, Dachau (DE)

(73) Assignee: KraussMaffei Technologies GmbH, München (DE)

(21) Appl. No.: 13/805,533

(22) PCT Filed: Jun. 16, 2011
(86) PCT No.: PCT/EP2011/060006

§ 371 Date: Dec. 19, 2012

(30) Foreign Application Priority Data
Jun. 29, 2010 (DE) 102010025501.7

(51) Int. Cl. B05B 7/14

(52) U.S. Cl. CPC B05B 7/149
USPC 239/400; 239/398; 239/428; 239/429; 239/399; 239/433

(57) ABSTRACT

The invention relates to a spray nozzle for addition of substances into a reactive mixture, comprising a housing (12), a connection (14) provided on the housing (12) and having an inlet (16) for the reactive mixture, wherein the connection (14) can be connected to a mixing head, and the inlet leads to a mixing chamber (30), and a material outlet opening (28) at the downstream end of the mixing chamber (30). In order to add pressure-sensitive substances, it is proposed to provide at least one supply (18) for the substance to be added, which has a channel (20) that is connected to the mixing chamber (30) via at least one inlet opening, and at least one air supply (22) which feeds into the mixing chamber (30) in flow direction downstream of the inlet opening via at least one air supply opening (26).

The present invention relates to a spray nozzle according to the preamble of claim 1.

Generally, it is known to admix further substances such as fillers, reinforcement substances, additives, etc. (hereinafter referred to as additional substance) to reactive mixtures, comprised for example of a polyurethane mixture, i.e., of isocyanate and polyol elements or of another multi-component system.

This can be done by mixing the solids outside of a mixing head into a spray jet. In this regard, reference is made for example to EP 1 458 494 B1. This process is however unsuitable for processing fillers having a very low density (for example so-called micro-glass bubbles of only a few μm diameter and a density of 0.2), because these substances for the most part are blown off from the added component by ambient air and only partially absorbed by the liquid.

Further admixture can be realized by introducing the additional substance or the additional substances into a mixing chamber in which the individual reactive components are added separately and mixed together. However, there are some materials, for example, those that are very sensitive and cannot be admixed as so-called batch component into the reactive mixture, in particular into the mixing chamber of a mixing head.

Oftentimes the isocyanate and polyol components—or the other components of a multi-component system—are atomized under high pressure in a mixing head and mixed together. This pressure—and the resultant force development can cause destruction of the particle structure, when sensitive substances are involved, and thus can lead to loss of the property that is desired later. This also applies to the afore-mentioned micro-bubbles of glass, as well as to expanded graphite or other sensitive materials.

It is an object of the present invention to provide a spray nozzle which allows introduction of also sensitive materials into a reactive mixture, with the entire mixture being atomizable subsequently.

This object is attained by the features set forth in claim 1.

Accordingly, the reactive mixture is initially prepared in a (conventional) mixing head, and supplied to the spray nozzle that is—preferably separate or provided at the end of the mixing head—via a connection. The connection has an inlet which is connected with a further mixing chamber. The sensitive material to be added is introduced into this mixing chamber via a separate supply and mixed homogeneously with one another in the mixing chamber under lesser high pressure.

Furthermore, air is subsequently introduced via an air supply and air supply openings into the mixing chamber by which the previously prepared mixture of the reactive mixture and the substance to be added is ejected. For that purpose, the air supply openings are preferably distributed about the mixing chamber at the end of the mixing chamber in flow direction. According to a preferred embodiment, the air supply has an annular space in the housing of the spray nozzle, which is connected with the plurality of air supply openings circumferentially disposed about the end of the mixing chamber, so that an even introduction of air across the periphery is possible. Further, it is advantageous when the air guide channels and/or the air supply openings are formed such that a swirl can be produced so that a fanned jet can be produced in a defined manner. Air supply is however not necessarily required. In the event, the mixture should simply be introduced into a molding tool, air supply may also be omitted.

In addition, the venturi effect may also be utilized. For this purpose, a venturi nozzle is formed at the outlet-side end of the (material) inlet and is connected to the same or further air inlet. Arranged between venturi nozzle and air inlet in the area of the (material) inlet is an air collecting space (e.g. annular space) which in particular surrounds the (material) inlet and across which the additionally supplied air is distributed into the venturi nozzle. With this preferred configuration, air flows at high speed into the mixing chamber, for example via the annular gap between the nozzle housing and a lance forming the (material) inlet. Suction is hereby generated at the inflow nozzles of the solid material as a result of the venturi effect and the filler is likewise drawn in. This causes an even transport of the substance being admixed into the reactive material mixture. The gap dimension may, for example be between 0.1 and 0.5 mm.

In order to be able to gently admix the substance being added into the reactive mixture within the mixing chamber, the injection nozzle has in terms of flow in its mouth region an orientation which preferably extends at an acute angle to the flow direction of the mixing chamber. In this way, the material flows are mixed together without great pressure and force impact on the particles.

Overall, the present invention is able to attain an introduction of even sensitive fillers (e.g. fragile fillers) into the reactive material mixture already within the nozzle in order to effectively prevent a release to the outside and to incorporate the substances to be introduced as completely as possible into the reactive material mixture.

A single exemplary embodiment of the invention will now be described in greater detail with reference to the accompanying drawings. The drawings show in

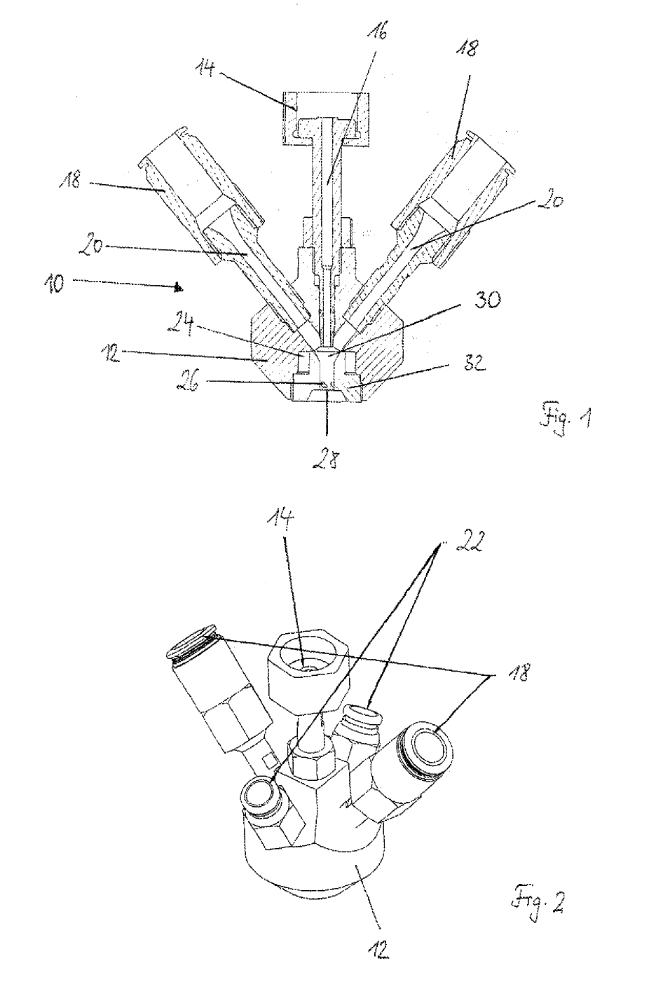

FIG. 1 a schematic sectional view of a first embodiment of a spray nozzle according to the invention,

FIG. 2 a schematic perspective view of the spray nozzle of FIG. 1,

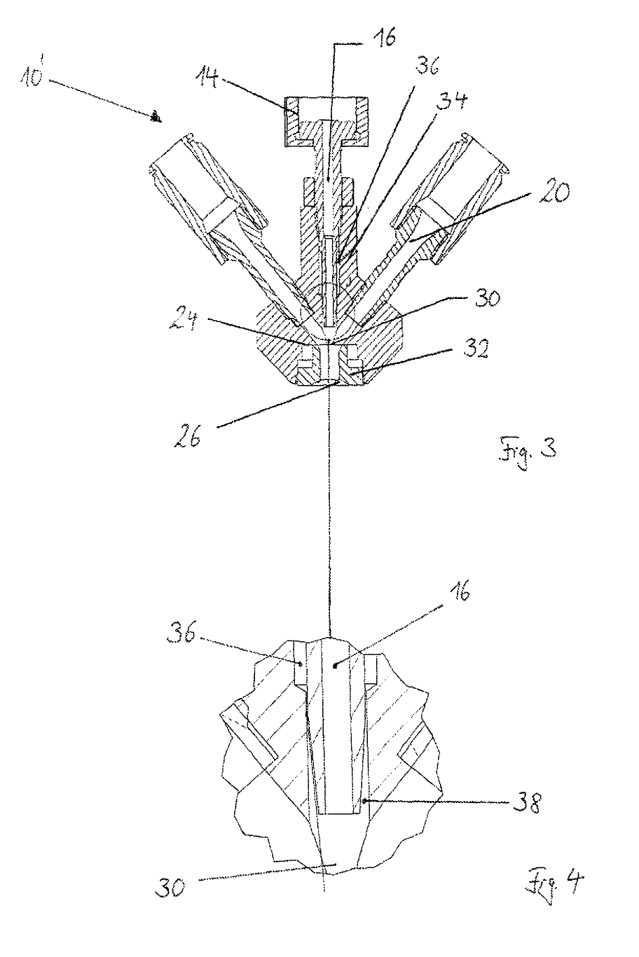

FIG. 3 a schematic sectional view of a second embodiment of a spray nozzle according to the invention, and

FIG. 4 an enlarged detail sectional view of the region marked with a circle in FIG. 3.

FIGS. 1 and 2 show a first embodiment of the spray nozzle 10 for addition of sensitive materials into a reactive mixture, including a housing 12 having an upper opening to provide a connection 14 which can be connected to a non shown mixing head. The connection 14 has an inlet channel 16 which feeds into a mixing chamber 30 of the housing 12.

Two channels 20 of two material supply devices 18 feed into this mixing chamber 30 for supply of the substances to be added to the mixing chamber 30 via respective lines and supply devices. It should be noted that this mixing chamber 30 is different from the mixing chamber of a mixing head, which latter mixing chamber is used for mixing the reactive components with one another. As a result, a reactive mixture is already being supplied to the mixing chamber 30 of the spray nozzle.

Examples of added substances include sensitive particles, such as micro-bubbles of glass or expansion graphite.

The channels 20 feed here at the upper end of the mixing chamber 30 at an acute angle into the mixing chamber 30 so that the sensitive substances can be added into the reactive material mixture within the mixing chamber 30 without being subject to great pressure and force. It is hereby also useful that the mixing chamber has a greater diameter than the inlet channel 16.

Air is being injected into the mixing chamber 30 via two air supply inlets 22 (see FIG. 2), which communicate with an annular space 24 within the housing 12, and via a plurality of air supply openings 26 which are circumferentially arranged about an end of the mixing chamber 30 in flow direction, with each air supply opening 26 being fluidly connected with the annular space 24 via air supply channels. The shape of the air supply openings 26 and the orientation of the air supply channels in relation to the air supply openings 26 are able to generate a swirling effect of the entire mixture to thereby provide a spray jet which is fanned in a desired manner.

The core component of the afore-described spray nozzle is the presence of an insert 32 which is insertable, in particular threadably engageable, into the housing 12 and allows realization of the mixing chamber 30, air supply as well as air injection.

The thus produced total mixture of the reactive mixture and the substance being added is sprayed out via a discharge opening 28 and applied onto the surface of a body to be coated.

FIGS. 3 and 4 show a second embodiment of a spray nozzle 10′ according to the invention. This spray nozzle 10′ corresponds, except for a few details, to the spray nozzle 10 of FIGS. 1 and 2. This is also expressed by using in FIGS. 3 and 4 the reference signs of FIGS. 1 and 2 for same or similar construction elements.

The construction of the spray nozzle 10′ differs from the one of the spray nozzle 10 in particular by the arrangement in the housing 12 of a further air supply 34 which ends in an annular space 36 that is arranged about the inlet 16 configured in the shape of a lance. A venturi nozzle 38 is formed by a corresponding taper of the lance (cf. FIG. 4) at the end of this inlet 16 for the reactive material mixture and is fluidly connected with the annular chamber 36.

In this configuration, air introduced via the inlet 34 flows at high speed into the mixing chamber 30 via the annular gap 36 between nozzle housing 12 and the lance forming the inlet for the reactive mixture. Suction is hereby generated at the ends of the inlet nozzles of the solid material (inflow channel 20) due to the venturi effect and the filler is aspirated. This causes an even transport of the substance being admixed into the reactive material mixture. The gap dimension shown in the figures may, for example, range between 0.1 and 0.5 mm.

Moreover, the spray nozzle 10′ has an outlet-side end (discharge opening 28) which is configured differently than the one of the spray nozzle 10.

The present spray nozzle enables even a pressure-sensitive substance to be admixed into a reactive mixture and to inject it therewith.

### LIST OF REFERENCE SIGNS

10, 10′ spray nozzle
12 housing
14 mixing head connection
16 inflow channel for reactive mixture (configured in lance)
18 inflow nozzle for solid material
20 inflow channel
22 air inflow nozzle
24 annular channel
26 inlet openings for spray air
28 discharge opening
30 mixing chamber
32 insert
34 additional air connection
36 annular space about inflow channel or lance
38 venturi nozzle

1. Spray nozzle for addition of substances into a reactive mixture, comprising
a housing (12),
a connection (14) provided on the housing (12) and having an inlet (16) for the reactive mixture, with the connection (14) being connectable to a mixing head on one hand, and leading to a mixing chamber (30) on the other hand,
a material outlet opening (28) at the end of the mixing chamber (30) in flow direction,
characterized in that
at least one supply device (18) for a substance to be added is provided in the housing (12) and has a channel (20) which is connected to the mixing chamber (30) via at least one inlet opening, and at least one air supply (22) is provided which feeds in flow direction downstream of the inlet opening into the mixing chamber (30) via at least one air supply opening (26).

2. Spray nozzle according to claim 1,
characterized in
that a venturi nozzle (38) is provided on the forward end of the inlet (16) and is connected with the air inlet or a further air inlet.

3. Spray nozzle according to claim 1,
characterized in
that a collecting space, in particular an annular chamber (36), is provided between venturi nozzle (38) and air inlet and arranged about the inlet (16).

4. Spray nozzle according to one of claims 1 to 3,
characterized in
that at least two supply devices (18) are provided for a substance to be added.

5. Spray nozzle according to one of claims 1 to 4,
characterized in
that the air supply (22) includes an annular space (24) which is connected with an air guide channel to the mixing chamber.

6. Spray can according to claim 5,
characterized in
that a plurality of air supply openings are arranged circumferentially about the end of the mixing chamber and connected to the annular space.

7. Spray nozzle according to claim 6,
characterized in
that the air guide channels and/or the air supply openings are configured so as to generate a swirl at the outlet of the mixing chamber.

8. Spray nozzle according to one of the preceding claims,
characterized in
that the axis of the injection nozzles in the mouth region extends at an angle, in particular at an acute angle, in relation to the flow direction in the mixing chamber.
